(19) United States
(12) Patent Application Publication
(10) Pub. No.: US 2026/0225829 A1
(43) Pub. Date: Aug. 6, 2026

(54) SYSTEMS AND METHODS FOR OBJECT PROCESSING WITH PROGRAMMABLE MOTION DEVICES USING VACUUM SLIDER GRIPPERS

(71) Applicant: Berkshire Grey Operating Company, Inc., Bedford, MA (US)

(72) Inventors: Jeffrey Ian LIPTON, Sharon, MA (US); Peter Gerard KELLY, Boston, MA (US)

(21) Appl. No.: 19/531,017

(22) Filed: Feb. 5, 2026

Related U.S. Application Data
(60) Provisional application No. 63/754,366, filed on Feb. 5, 2025.

(51) Int. Cl. B65G 47/91; B25J 15/06

(52) U.S. Cl. CPC B65G 47/917; B25J 15/0625

(57) ABSTRACT

Systems and methods are provided for processing objects using a programmable motion device equipped with a vacuum-based end-effector. The end-effector includes multiple contact portions arranged at an angle to engage more than one surface of an object. Each contact portion includes one or more vacuum openings, and at least one may be adjustable to vary the effective vacuum engagement area. A perception subsystem may identify an exposed surface of the object to guide end-effector configuration and motion planning. In some embodiments, a movable contact portion includes a wedge-shaped tip to separate tightly packed items, while vacuum-actuated flaps improve sealing and grasp stability. The system may include a modular end-effector exchange mechanism, enabling different tools to be automatically selected for varied object types. These features support high-throughput object handling across a range of object shapes, sizes, and materials, including items with internal degrees of freedom such as books or shoeboxes.

### PRIORITY

This application claims priority to U.S. Provisional Patent Application No. 63/754,366 filed February 5, 2025, the disclosure of which is hereby incorporated by reference in its entirety.

### BACKGROUND

The invention generally relates to programmable motion systems and relates in particular to end-effectors for programmable motion devices (e.g., robotic systems) for use in object processing systems such as object sortation systems.

End-effectors for robotic systems may be employed, for example, in certain applications to select and grasp an object, and then move the acquired object very quickly to a new location. End-effectors should be designed to quickly and easily select and grasp an object from a jumble of dissimilar objects, and should be designed to securely grasp an object during movement. Certain end-effectors, when used on different objects of different physical sizes, weights and materials, may have limitations regarding how securely they may grasp an acquired object, and how securely they may maintain the grasp on the object during rapid movement, particularly rapid acceleration and deceleration (both angular and linear). Further, in certain applications it may be desired to place an object at a destination in a required orientation or pose, particularly with respect to an environment such as a container being packed by a robotic system.

Many end-effectors employ vacuum pressure for acquiring and securing objects for transport and/or subsequent operations by articulated arms. Other techniques for acquiring and securing objects involve electrostatic attraction, magnetic attraction, needles for penetrating objects such as fabrics, fingers that squeeze an object, hooks that engage and lift a protruding feature of an object, and collets that expand in an opening of an object, among other techniques.

In applications where vacuum pressure is used to acquire and secure objects, an end-effector on an articulated arm may include a vacuum cup having a compliant portion, e.g., a bellows portion that contacts the object to be grasped. The compliant portion may be formed of a polymeric or elastomeric material that is flexible enough to allow it to change its shape to adapt to variations in object surface structures, and to varying physical relationships between the articulated arm and the object, such as for example varying angles of approaches to objects. The flexibility further allows the vacuum cup to conform to the shape of objects or to wrap around corners of objects to create an adequate seal for acquiring and securing the object.

Other types of end-effectors including vacuum cups with less flexible compliant portions (in addition to those using electrostatic attraction, magnetic attraction, needles for penetrating objects such as fabrics, fingers that squeeze an object, hooks that engage and lift a protruding feature of an object, and collets that expand in an opening of an object), are less effective at acquiring and moving a wide variety of objects.

Such applications in which a robotic system needs to accurately process a wide variety of sizes of objects relative to an environment include, for example, packing multi-unit e-commerce orders into a container, packing a single unit into an automated bagging system, packing or consolidating containers used in an automated storage and retrieval system (AS/RS), and scanning objects in front of scanners such as barcode scanners or RFID scanners.

Vacuum end-effectors however, may be limited in their ability to acquire objects of a wide variety of sizes, such as if the object being processed includes a small or narrow face that is exposed to the end-effector. For example, bins of thin objects that are tightly packed in an input bin present certain challenges including how to properly access and grasp an object, as well as how to avoid grasping multiple objects.

Further, objects may sometimes be encountered that have internal degrees of freedom when grasped, such as an unsealed shoe box, an unsealed book or a folded pair of pants. Such objects may open if lifted by a single surface. Additionally, traditional pinch grippers and vacuum cup grippers may have difficulty accessing individual objects in densely-packed totes from a warehouse.

There remains a need therefore, for systems and methods for more efficiently and effectively grasping, manipulating, and packing objects by efficiently acquiring objects of a wide variety of sizes without adversely impacting throughput.

### SUMMARY

In accordance with an aspect, the invention provides an object processing system that includes an input area at which objects are presented to a programmable motion device, a perception system for providing perception data regarding an object to be processed that is at the input area and an end-effector operatively coupled to the programmable motion device. The end-effector includes a first contact portion and a second contact portion, each contact portion configured to engage an external surface of an object and each contact portion comprising at least one vacuum opening. The first and second contact portions are positioned non-parallel relative to one another to allow the end-effector to engage the object on separate surfaces. The second contact portion provides a converging movement relative to the first contact surface, and moves a converging slider relative to the second contact portion.

In accordance with another aspect, the invention provides an object processing system that includes an input area at which objects are presented to a programmable motion device, a perception system for providing perception data regarding an object to be processed that is at the input area, and an end-effector coupled to the programmable motion device, the end-effector including a first contact portion and a second contact portion, each of the first and second contact portions being generally planar and each including at least one opening through which vacuum may be provided, the second contact portion being generally non-parallel to the first contact portion, and the second contact portion being movable with respect to the first contact portion at least in an engagement direction such that more than one surface of the object may be grasped by the end-effector. In some embodiments, the contact portions may be non-planar, including curved, angled, or conformable surfaces. The shape of each contact surface may be selected to match an object profile or to optimize vacuum engagement on irregular or flexible objects. In some embodiments, the contact portions may be positioned at non-perpendicular angles to accommodate specific object geometries or system constraints.

In another aspect, an object processing system is provided that includes an input area at which objects are presented to a programmable motion device, a perception system for providing perception data regarding an object to be processed that is at the input area, and an end-effector coupled to the programmable motion device, the end-effector including a first contact portion and a second contact portion, each of the first and second contact portions being generally planar and each including at least one opening through which vacuum may be provided, the second contact portion being generally non-parallel to the first contact portion, and the first contact portion including an actuator for adjusting a volume of vacuum flow at the first contact portion. While some embodiments include a perception subsystem to identify an exposed surface of the object (e.g., perception units 21, 60, and 62 in FIGS. 2 and 5), other embodiments may operate based on predefined object positions, stored object geometry, or external input. In such cases, the system may engage an object without actively analyzing its orientation or face.

In yet another aspect, a method of processing objects in an object processing system is provided that includes receiving an object at an input area proximate a programmable motion device, providing an end-effector coupled to the programmable motion device, the end-effector including a first contact portion and a second contact portion, each of the first and second contact portions being generally planar and each including at least one opening through which vacuum may be provided, the second contact portion being generally orthogonal to the first contact portion, moving the second contact portion with respect to the first contact portion at least in a direction that is generally non-parallel to the first contact portion and contacting more than one surface of the object to grasped by the end-effector.

### BRIEF DESCRIPTION OF THE DRAWINGS

The following description may be further understood with reference to the accompanying drawings in which:

FIG. 1 shows an illustrative diagrammatic view of an object processing system including a programmable motion device with a variable-sized applicator surface end-effector in accordance with an aspect of the present invention;

FIG. 2 shows an illustrative diagrammatic overhead view of the object processing system of FIG. 1;

FIG. 3 shows an illustrative diagrammatic front elevational enlarged view of the programmable motion device of the object processing system of FIG. 1;

FIG. 4 shows an illustrative diagrammatic rear elevational enlarged view of the programmable motion device of FIG. 3;

FIG. 5 shows an illustrative diagrammatic view of an input area of the object processing system of FIG. 1;

FIG. 6 shows an illustrative diagrammatic enlarged view of the programmable motion device of the object processing system of FIG. 1 grasping an object;

FIG. 7 shows an illustrative diagrammatic exploded assembly view of the end-effector of the programmable motion device in the system according to FIG. 1;

FIGS. 8A and 8B show illustrative diagrammatic exploded views of the end-effector according to FIG. 7 with FIG. 8A showing an elevated exploded view, and FIG. 8B showing an underside view;

FIGS. 9A - 9D show illustrative diagrammatic views of a rack engagement system for exchanging end-effectors, with FIG. 9A showing a pin alignment mechanism, FIG. 9B showing the pin alignment mechanism when engaging with the programmable motion device; FIG. 9C showing the engagement of the pin alignment mechanism, and FIG. 9D showing the end-effector engaged with the programmable motion device;

FIGS. 10A and 10B show illustrative diagrammatic views of an alternative rack engagement system for exchanging end-effectors, with FIG. 10A showing a magnetic alignment mechanism, and FIG. 10B showing the attachment portion of the end-effector coupled to the programmable motion device;

FIGS. 11A and 11B show illustrative diagrammatic views of an yet another rack engagement system for exchanging end-effectors, with FIG. 11A showing an alignment mechanism with locating features, and FIG. 11B showing the attachment portion of the end-effector coupled to the programmable motion device;

FIGS. 12A and 12B show illustrative diagrammatic views of the end-effector of the present invention with FIG. 12A showing an element of the end-effector in a retracted position, and FIG. 12B showing the element in an extended position;

FIGS. 13A and 13B show illustrative diagrammatic views of the end-effector of the present invention enhanced with positional controls with FIG. 13A showing the enhancement when an element of the end-effector in a retracted position, and FIG. 13B showing the enhancement when the element in an extended position;

FIGS. 14A - 14C show illustrative diagrammatic views of an aspect of the end-effector of the present invention that performs horizontal translation, with FIG. 14A in a first translational position, FIG. 14B in a second translational position, and FIG. 14C in a third translational position;

FIGS. 15A and 15B show illustrative diagrammatic views of the aspect of the end-effector according to FIGS. 14A - 14C with FIG. 15A in a first position, and FIG. 15B in a second position;

FIGS. 16A and 16B show illustrative diagrammatic exploded views of the end-effector of the present invention with FIG. 16A viewed from a first perspective, and FIG. 16B viewed from a second perspective;

FIGS. 17A and 17B show illustrative diagrammatic views of the end-effector of the present invention from an underside perspective, with FIG. 17A showing a feature of the end-effector in a first position, and FIG. 17B showing the feature in a second position;

FIGS. 18A and 18B show illustrative diagrammatic views of the end-effector of the present invention with FIG. 18A showing the end-effector moving in a first direction, and FIG. 18B showing the end-effector moving in a second opposite direction;

FIG. 19 shows an illustrative diagrammatic view of the end-effector of the present invention grasping a book;

FIG. 20 shows an illustrative diagrammatic enlarged view of the end-effector of the present invention as shown in FIG. 19;

FIG. 21 shows an illustrative diagrammatic view of the end-effector of the present invention as shown in FIG. 19 from a different perspective;

FIG. 22 shows an illustrative diagrammatic view of the end-effector of the present invention grasping the book object from an alternative orientation;

FIG. 23 shows an illustrative diagrammatic enlarged view of the end-effector of the present invention as shown in FIG. 22; and

FIG. 24 shows an illustrative diagrammatic enlarged view of the end-effector of the present invention grasping an object with an openable top.

The drawings are shown for illustrative purposes.

### DETAILED DESCRIPTION

Applicants have discovered that end-effectors may be provided that may effectively and efficiently grasp items including, but not limited to, books, shoe boxes, and other common items with internal degrees of freedom using vacuum actuation, be integrated into a cup swap system with standard suction cups, may either be mechanically or electromechanically actuated to adapt to different book/shoe box sizes, and may detect changes in vacuum pressure for sensing grasps. In accordance with various aspects, the invention provides a book/shoe box gripper that includes a main housing, to which the following components are mounted: a compliant gripper attachment, a horizontal slider housing and linear rail/bearing, and a converging (e.g., vertical) slider.

Object processing systems in accordance with various aspects of the invention employ any of a variety of high flow vacuum end-effectors that are used for different objects during object processing as discussed herein. A challenge with using high flow vacuum is that if the vacuum cup contact surface contacts plural objects, the plural objects may all be grasped because the high flow vacuum system does not require that the vacuum cup tightly seal a closed surface area of the object being grasped. Using a vacuum cup therefore that contacts plural objects may well grasp many of the plural objects using the high flow vacuum.

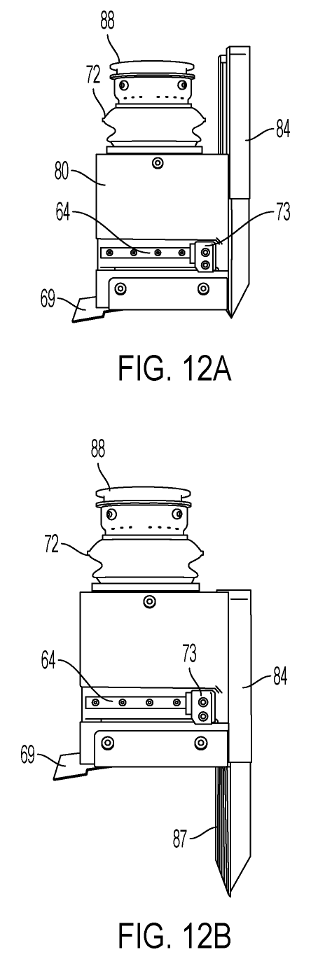

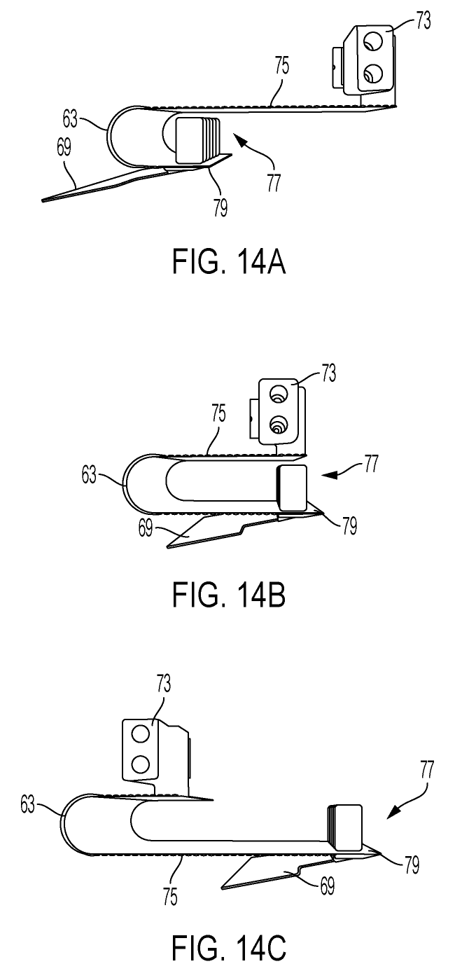

As used herein, a “contact portion” refers to a region or structure of the end-effector that includes a vacuum engagement surface, and may include sliders, flaps, combs, channels, or other mechanical components for modulating vacuum or positioning, such as contact portion 75 (horizontal slider) shown in FIGS. 14A–14C, and contact portion 84 (converging, e.g., vertical slider) shown in FIG. 12B. A “contact surface” refers to the specific face or region of a contact portion that interfaces with the object. An “engagement direction” refers to the direction of motion used to bring the second contact portion toward the object or the first contact portion, such as the downward movement of contact portion 84 in FIG. 12B.

Applicants have discovered that a vacuum applicator may be provided that can wedge into spaces to separate objects and then access a side surface of an object for application of suction. Simply mounting a suction cup on a sideways mount would not provide the correct structure because standard suction cups often have bellows that are designed to provide compliance when aligning from above however this compliance when grasping from the side allows an object to create a torque that makes the grip weaker, and is difficult to use as it creates a bulky structure that cannot wedge between objects. In accordance with various aspects the invention provides an end-effector that can wedge between objects, that can grasp objects using only suction and friction from one side, that are compliant enough to conform to the face of an object, and that can grasp thin objects without damaging them.

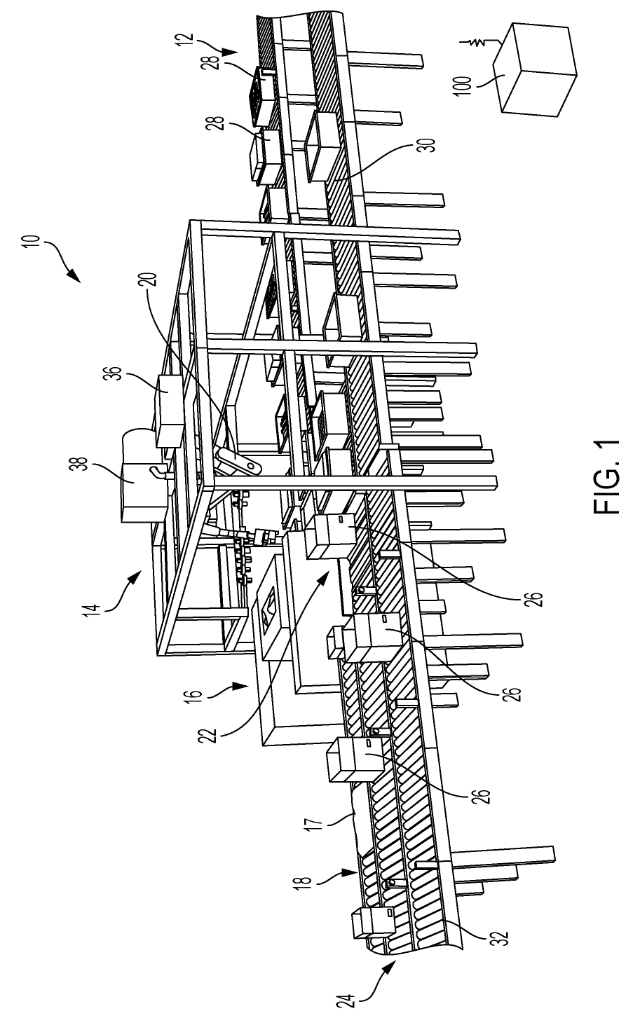

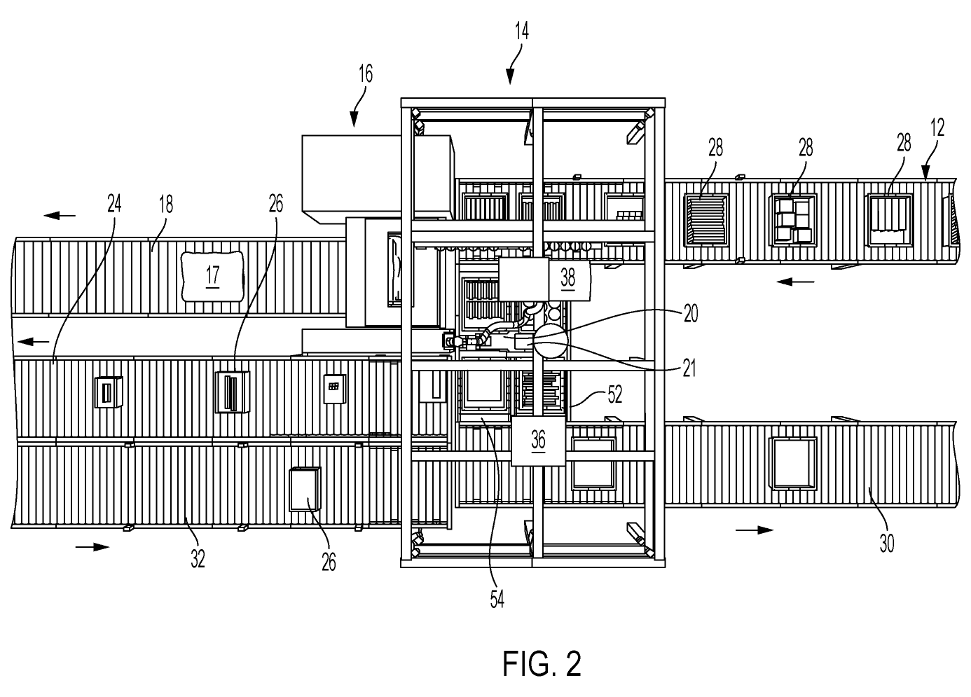

FIG. 1 shows an object processing system 10 in accordance with an aspect of the present invention that includes an input source conveyor 12 that provides objects to be processed to a processing station 14 that includes a programmable motion device 20. The programmable motion device 20 is used to grasp and move objects received at an input area 34 (shown in FIG. 2) from the input source conveyor 12, and to provide objects to any of an auto-bagging system 16 that provides objects in sealed bags 17 along an auto-bagging system conveyor 18, or to provide objects to output containers 26 (e.g., shipping boxes) provided at a packing area 22 on a container output conveyor 24. The objects to be processed may be provided in input source containers 28.

With further reference to FIG. 2, a top view shows the input source conveyor 12 that brings input objects (e.g., in bins 28) to the input area 34. The input area 34 includes two conveyor sections 52, 54 that receive objects from the input source conveyor 12, and both conveyor sections 52, 54 lead to a source container return conveyor 30 as shown in FIG. 2. Empty output containers 26 are provided along an empty output container conveyor 32 to the processing station 14, and are routed to the packing area 22 where they are packed prior to being moved along the container output conveyor 24. Operation of the conveyors and other components of the system is provided by the one or more computer processing systems 100 as discussed herein, and the programmable motion device may include its own processing control system 36 in communication with the one or more computer processing systems 100.

With reference again to FIG. 1, the programmable motion device 20 includes an end-effector attachment portion (shown in more detail in FIG. 4) that is coupled to a high flow vacuum source 38, such as for example, a side-channel blower, air amplifiers or multistage ejectors. The high flow vacuum source 38 may, for example, provide at the end-effector attachment portion 40 an air flow of at least about 100 cubic feet per minute, and a vacuum pressure of no more than about 100,000 Pascals below atmospheric, or no more than about 85,000 Pascals below atmospheric, or no more than about 65,000 Pascals below atmospheric. Again, the use of such a high flow vacuum source, while providing benefits in grasping objects where a seal is not tightly formed between the vacuum cup and the object, presents challenges in grasping only one object among a plurality of objects.

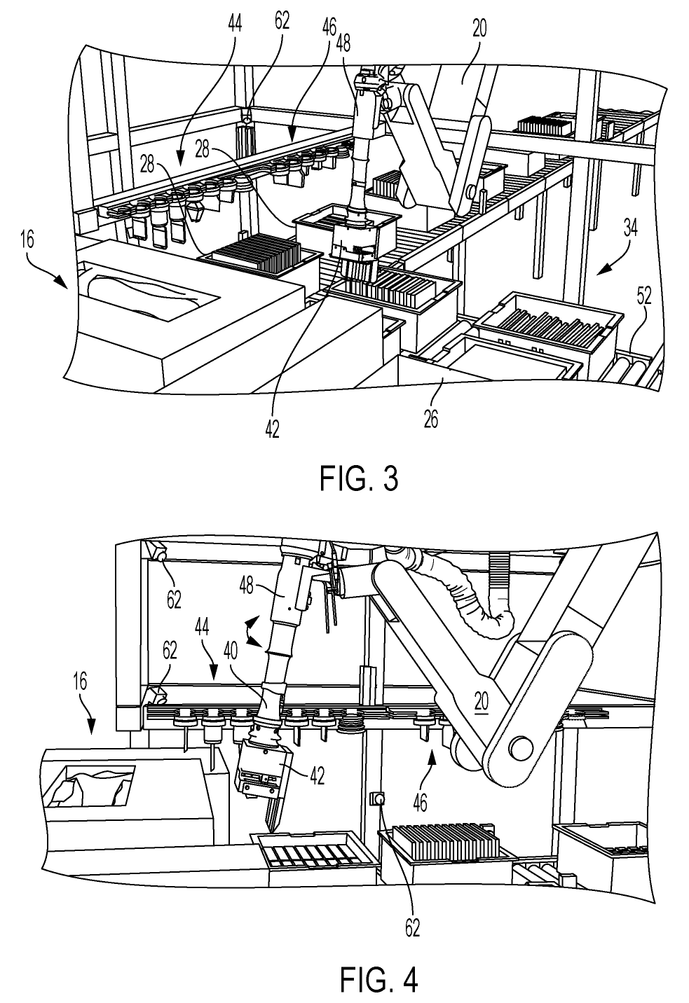

With reference to FIG. 3, an end-effector 42 may be attached to the end-effector attachment portion 40 of the programmable motion device. Objects are received at an input area 34, either individually or in groups on input conveyor sections 50, 52 or in bins or totes as shown. Plural additional end-effectors may be provided on one or more end-effector racks 44, 46 as further shown in FIG. 4. The programmable motion device is programmed to be able to engage and disengage any of the end-effectors on the racks 44, 46 as further discussed below. The end-effector attachment portion 40 is mounted within a collar 48 that is attached to the programmable motion device 20, and an opposite end of the end-effector attachment portion (that extends out the other side of the collar 48) is coupled to a vacuum hose 50 that is coupled to the vacuum source 38.

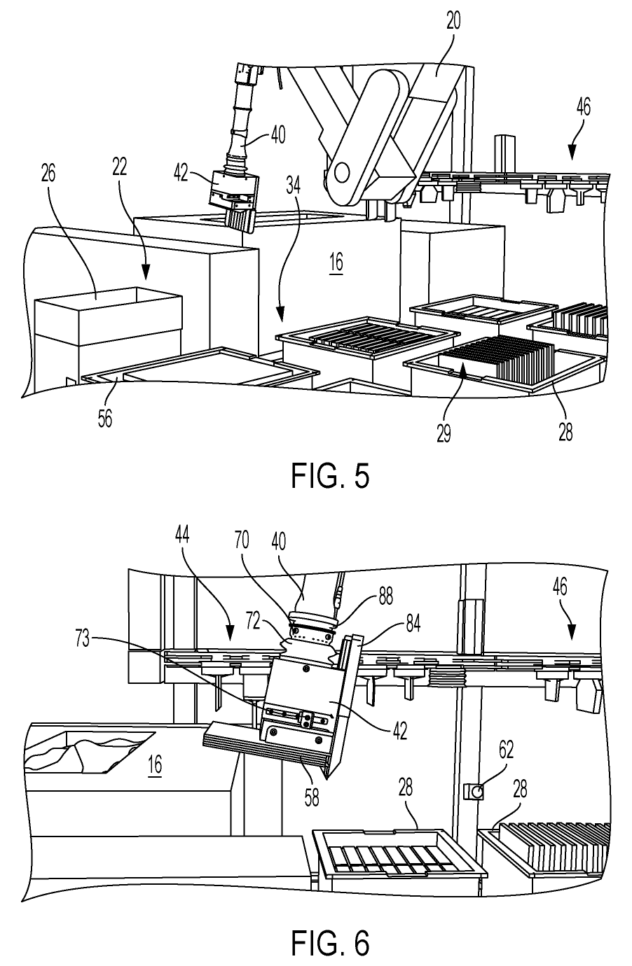

As shown in FIG. 5, exemplary objects 29 to be processed by the system may come in a variety of sizes, with varying exposed face sizes available for grasping. The system receives such objects at an input area 34, which defines a region accessible to the programmable motion device and is shown in FIGS. 3 and 5. The input area 34 includes two conveyor sections 52 and 54 (shown in FIG. 2), which deliver containers or trays into the reach of the end-effector. In certain applications, these conveyor sections may operate independently or cooperatively and may optionally include right-angle-transfer mechanisms (e.g., raisable belts) to reposition containers between the conveyor sections 52 and 54. An input container (e.g., container 56) may include objects with a large aspect ratio but only small-sized faces exposed to the programmable motion device. In accordance with an aspect of the present invention, the system may select an end-effector (e.g., 42) to grasp n specific object 58 from the input container 56, as shown in FIG. 6. A perception system (e.g., including perception units 62 and perception unit 21 shown in FIG. 2) provides perception data regarding an object that is in the input area, and this data includes information representative of an exposed face of the object and may be used to determine which end-effector to use and how to engage the object. The system may include conveyor perception units 60 along the input source conveyor 12 as well as the perception units 62 on the support structure from which the programmable motion device is suspended to support (together with the computer processing systems 36, 100) in operation of grasping, moving and placing objects into any of, for example, output containers 26 or sealed bags 17 as discussed herein. While perception units may be used to analyze the orientation or visible surface of an object, in some implementations, object handling is based on known pick locations or object classifications without live sensor feedback.

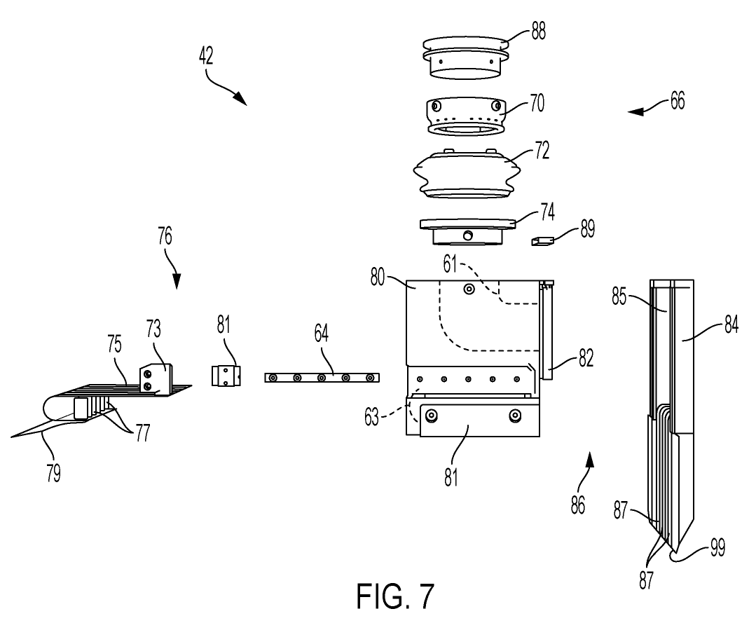

With further reference to FIG. 7, the end-effector 42 includes a housing 80 that is coupled via an attachment assembly 66 to the end-effector attachment portion 40 (shown in FIG. 6) at the proximal end of the housing, and in particular, at an opening of an elbow-shaped (right angle) channel 61. The attachment assembly 66 includes a housing mount 74 attached thereto that is coupled at its proximal end to a flexible bellows 72, that is attached to a coupling collar 70, that is attached to an annular mounting ring 88 that permits the end-effector to engage with a rack 44, 46. The annual mounting ring 88 attaches the end-effector to the attachment portion 40. The flexible bellows 72 permits substantial freedom of movement (e.g., pitch and roll) with respect to the end-effector attachment portion 40.

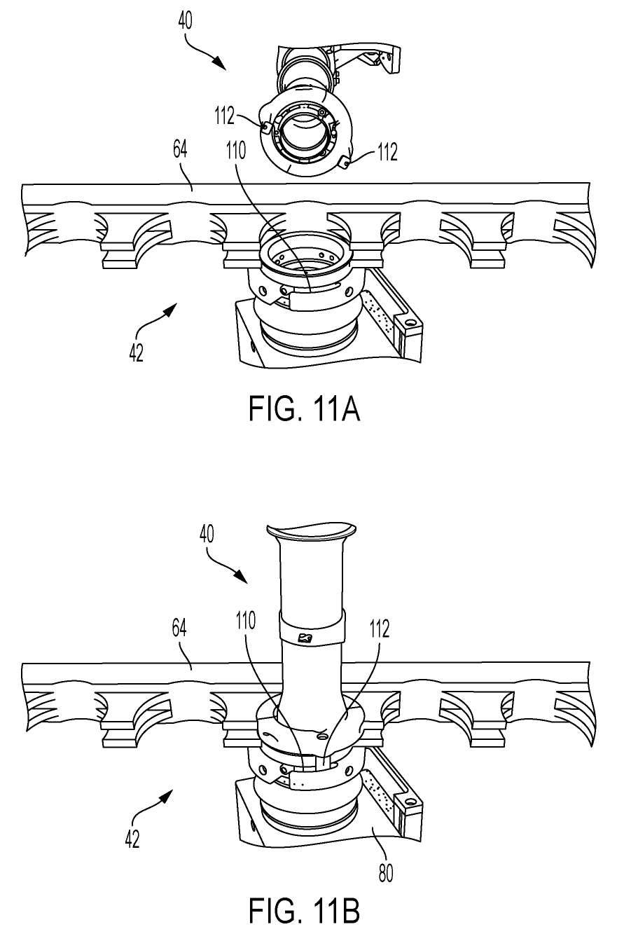

The housing attaches to the vacuum source through the compliant gripper attachment. The gripper attachment has a set of bellows 72, which give the gripper enough compliance to adapt to errors in the positioning of the robotic arm relative to items that it is attempting to grasp. In accordance with certain aspects (as discussed below with reference to FIGS. 11A and 11B) the gripper attachment also may include two grooves, which lock into locating features mounted to a suction tube that is attached to a robot arm. The robot can twist this suction tube, allowing it to automatically lock into place. This allows the robot to swap between various types of grippers, including the book/shoe box gripper. The locating features also resist forces and torques that could otherwise cause the gripper to fall off the suction tube.

In accordance with certain aspects, the invention provides an end-effector system for programmable motion devices (e.g., robotic systems) that provides high flow vacuum together with one or more sliders that facilitate accommodating objects of various sizes, weights and objects having internal degrees of freedom. The high flow vacuum is provided at an end-effector vacuum applicator of the robotic system, and the vacuum applicator is coupled to a high flow vacuum system. The vacuum applicator is attached to a cup attachment portion, which is in turn attached to an arm attachment portion that is attached to an articulated arm of the robotic system.

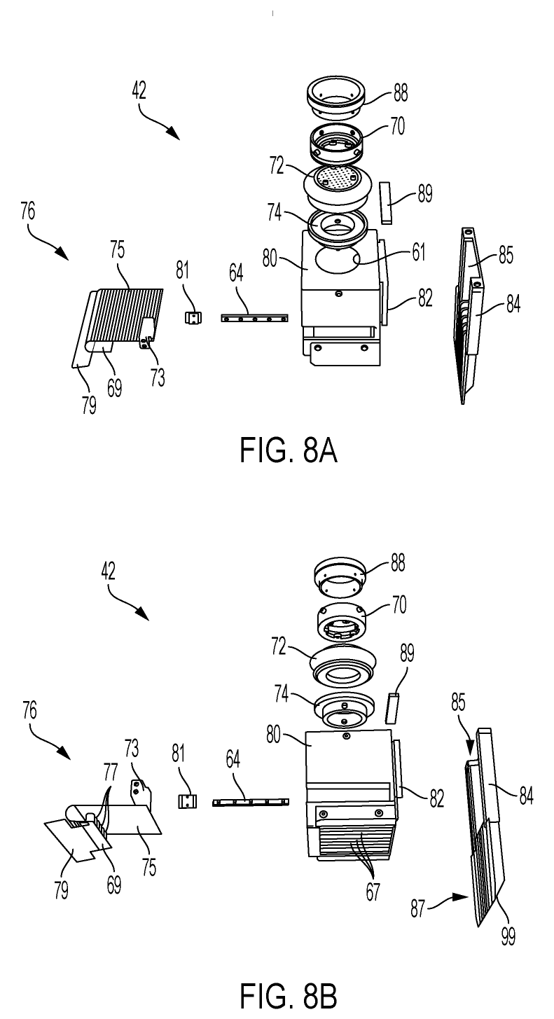

With continued reference to FIG. 7, the end-effector 42 also includes a vacuum flow control mechanism, such as a horizontal slide adjustment system (actuator) 76 that includes a flexible horizontal slider 75 with an attached slider tab 73 and a volume-blocking comb 77 on the underside. The slider tab 73 rides with a linear bearing 81 along a horizontal rail 64 mounted on the housing 80. As the slider tab 73 is moved, the flexible horizontal slider 75 is urged downward and in a reverse direction by an inner curved surface 63 within the housing 80. A flexible flap 69 (shown in FIGS. 8A and 8B) and a sealing foam 79 are mounted to the leading edge of the flexible horizontal slide 75. The horizontal slide adjustment system and the vertical slide adjustment system are generally mutually perpendicular (e.g., within 80 degrees to 100 degrees of each of other), and provide the vacuum force where the two slide adjustment systems join at a vacuum corner edge. Additionally, the vertical open channels and the horizontal open channels are provided between ridges (e.g., plastic or metal) that maintain their shape under the force of the vacuum, permitting the vacuum force applied to the object to be evenly distributed while maintaining the openness of the channel to provide the vacuum.

While the first and second contact portions are shown in the figures as being generally orthogonal—such as the vertical and horizontal contact surfaces shown in FIGS. 8B, 12B, and 14A—this particular angular arrangement is not required, and the first and second contact portions may generally be non-parallel. In other embodiments, the contact portions may be positioned at non-orthogonal angles, including acute or obtuse configurations, depending on the geometry of the objects to be grasped or the spatial layout of the system. For example, contact surfaces may be arranged at angles of 30°, 45°, 60°, 120°, or other non-right angles, either fixed or adjustable. In some cases, one or both contact portions may be formed of or supported by compliant or flexible materials, such that the effective engagement angle may vary dynamically during object contact. The angular relationship between contact portions may be selected to optimize surface contact, packing efficiency, or system integration, and may include curved transitions between surfaces in some embodiments.

The horizontal slider 75 is designed to be thin, flexible, and housed within a track in the horizontal slider housing. As the tab 73 of the horizontal slider 75 is pushed inward and outward, it expands and contracts the horizontal suction surface at the distal end of the gripper. The horizontal slider wraps around the track and makes a 180° turn inside its housing. This design allows the gripper to be more compact, allowing it to more effectively operate in cluttered warehouse totes. The slider also has “teeth” on the volume-blocking comb 77 on its bottom side, which act as seals inside the horizontal slider housing to direct the incoming air in the desired direction. The need for these “teeth” instead of one continuous surface is due to the need for a support structure in the housing under the horizontal slider to support it under high vacuum pressure. This prevents low pressure from building up in the closed region of the gripper, which can result in unintended picks. This slider 75 also has the flexible flap 69 mounted to the leading edge, allowing it to seal around various surfaces of books, shoe boxes, and other items.

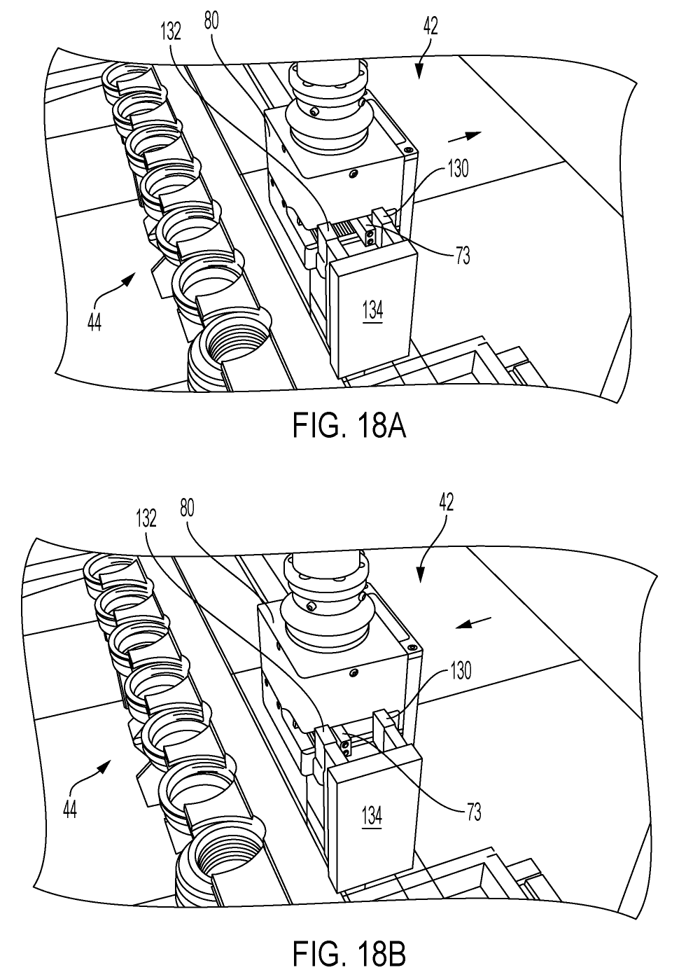

The additional piece of rubber foam 79 is added on the leading edge as well to better seal against the edges of SKUs to prevent unintentional/multi-picks. Flexible flaps 81 are mounted on the sides of the horizontal slider housing to fully seal the horizontal suction surface. The flexible flaps 81 (e.g., rubber flaps) are drawn by the vacuum to urge against an object being grasped to further engage and grasp the object. The horizontal slider can be relatively fragile, so the slider tab is mounted to a linear bearing 81 and rail 64 to isolate it from external forces and torques. The tab 73 interacts with a gripper adjustment plate mounted in the robotic cell in which it is being operated (as discussed below with reference to FIGS. 18A, 18B), which allows the robot to adjust the grippers’ slider lengths prior to it grasping an item.

The end-effector 42 further includes a vertical slide adjustment system 86 that includes a converging slider such as a vertical slider 84 that rides along a vertical track 82 on the housing 80. The converging slider provides converging movement of the second contact portion relative the first contact portion, and in accordance with certain aspects, the movement of the second contact portion will increase or decrease the amount of vacuum flow at the at least one opening of the second contact portion. The converging movement is generally non-parallel to the first contact portion and may be ion an axial direction relative the programmable motion device (e.g., vertical as shown in FIG. 7) to provide, for example, a plunging movement relative the objects at the input area. An open cavity 85 is provided on an inner side of the vertical slider 84 is in communication with the distal end of the channel 61. A foam pad 89 mounted to the housing 80 substantially seals the cavity 85 at the upper end and provides a small degree on friction in movement of the vertical slider 84 with respect to the housing 80. Distal vertical open channels 87 are provided at the distal end of the vertical slider 84 in communication with the cavity 85, and provide a generally planar contact surface at the channels 87. Vacuum is therefore drawn up through the distal open channels 87, through the cavity 85, through the channel 61 and up through the end-effector mounting hardware to a hose and the vacuum source.

The converging (e.g., vertical) slider 84 of the gripper therefore mounts to the main housing 80 and can slide up and down to adjust for the height of the object being grasped. An internal seal in the main housing prevents air from escaping between the housing and vertical slider when vacuum is applied by the foam pad 89. The flexible flaps 83 (e.g., rubber flaps) are also drawn by the vacuum to urge against an object being grasped to further engage and grasp the object. The vertical slider has a wedged tip 99 at its distal end, which allows it to effectively pry apart items that are packed tightly together to pick just one selected item. The vertical slider should have enough resistance to do this wedging action, but not too much resistance to sliding that the robot cannot adjust it at the gripper adjustment plate. Currently, the seal applies the resistance force through friction. However, this force could be increased with preloaded springs or spring pins. This force could also be temporarily increased by applying variable vacuum pressure. Since the main housing internal channels direct the air flow away from the vertical slider, it dramatically increases the friction between the main housing and vertical slider when vacuum is applied. This can be used to increase sliding resistance when wedging between books. Instead of using the gripper adjustment plate, the position of the vertical slider could also potentially be adjusted against a surface inside the tote of a known height (e.g., a book, bottom of tote) for faster adjustment than returning to the gripper adjustment plate. The vertical slider also has flexible flaps to better seal against uneven surfaces.

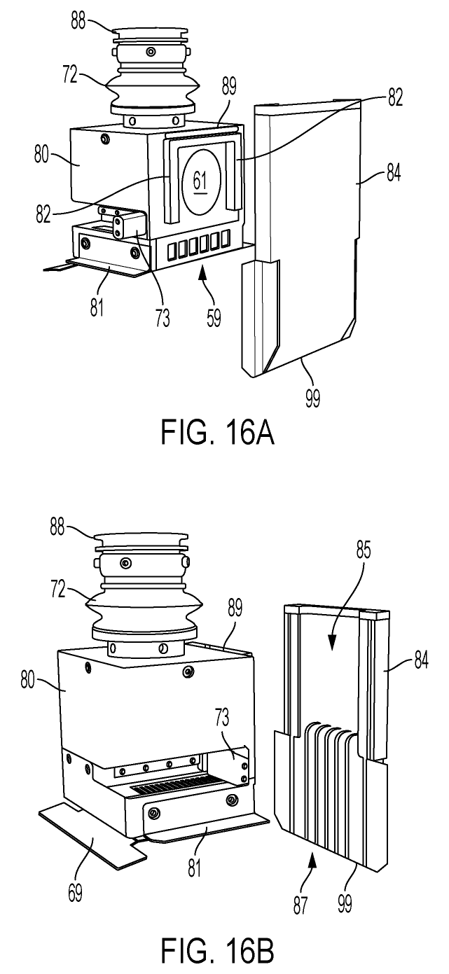

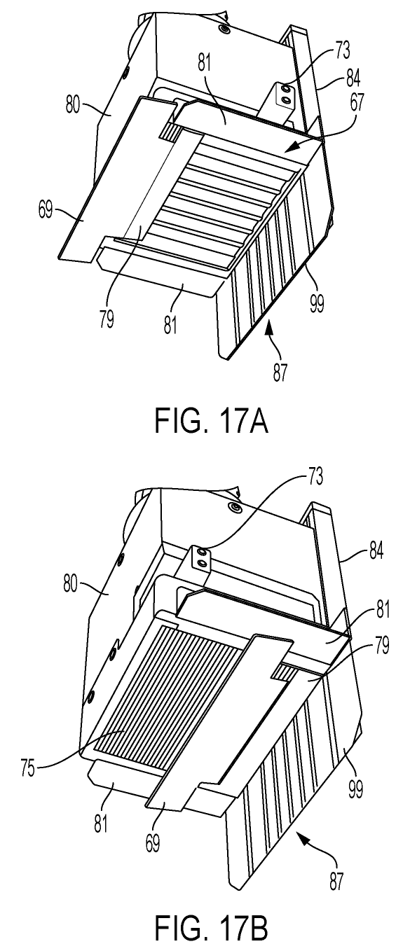

FIG. 8A shows an elevated exploded view of the end-effector 42 showing the open top to the cavity 85 that is sealed by the foam pad 89. FIG. 8B shows an underside exploded view of the end-effector 42 showing horizontal open channels 67 at the distal end of the end-effector. The horizontal open channels 67 are in communication with the vertical open channels 87 through openings 59 (shown in FIG. 16A). The vacuum is therefore provided via right angle channel 61, open cavity 85 of vertical slider 84, and openings 59 to both the planar exposed surface of the horizontal slider 75 and the planar exposed surface of the vertical slider 84. The planar surface of the horizonal slider 75 and the planar exposed surface of the vertical slider are generally mutually orthogonal, permitting more than one surface of an object to be grasped by the contact portions of the horizontal open channels 67 and the contact portions of the vertical open channels 87 (shown in FIG. 8B). The teeth of the comb 77 fit with the horizontal open channels and direct the flow of vacuum from the distal end of the end-effector up into the horizontal open channels, through the openings 59 (shown in FIG. 17A) and into the vertical open channels 87. The volume of vacuum flow at the planar surface of the horizontal slider 75 is therefore adjustable by the actuator 76. Again, as the tab 73 of the horizontal slider 75 moves, more or less of the distal surface of the horizontal open channels are exposed to an object to be grasped. Again, the flexible flaps 81, 83 (e.g., rubber flaps) are drawn by the vacuum to urge against an object being grasped to further engage and grasp the object.

In accordance with various aspects, the book/shoe box gripper may effectively grasp objects with internal degrees of freedom. Since the horizontal and vertical sliders are oriented about 90° from each other, they may keep items like books and shoe boxes closed throughout the picking process. The vertical and horizontal suction surfaces work together to lock these items into their current state, preventing unfurling or opening. For hardcover books, where the covers extend further outward than the pages, the flexible flaps seal against this uneven surface. Between each item type, the gripper can be reconfigured at the gripper adjustment plate to ensure it has the optimal suction surface dimensions for each item.

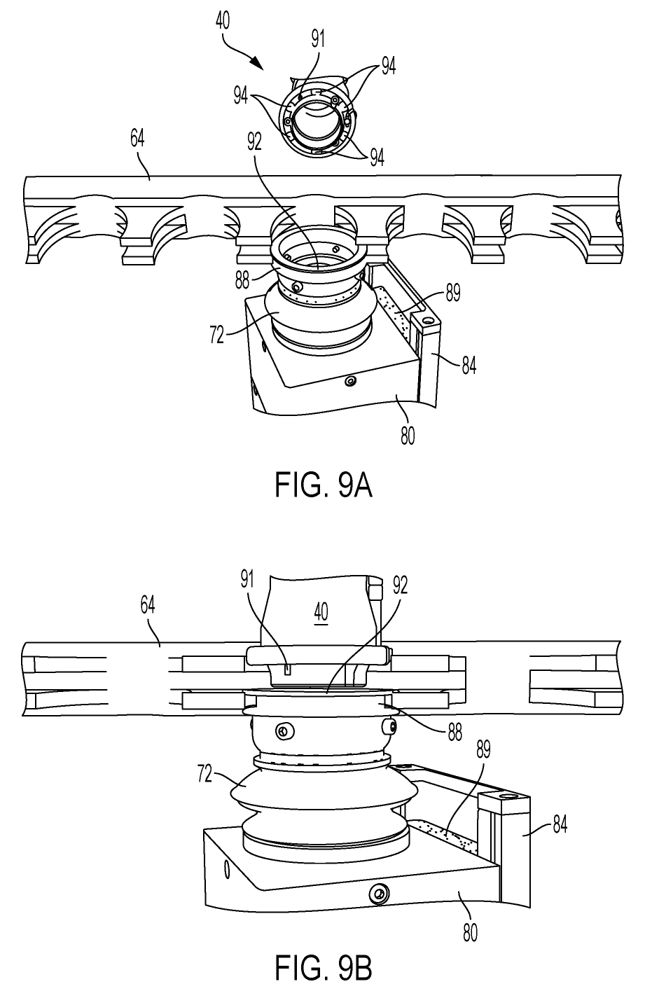

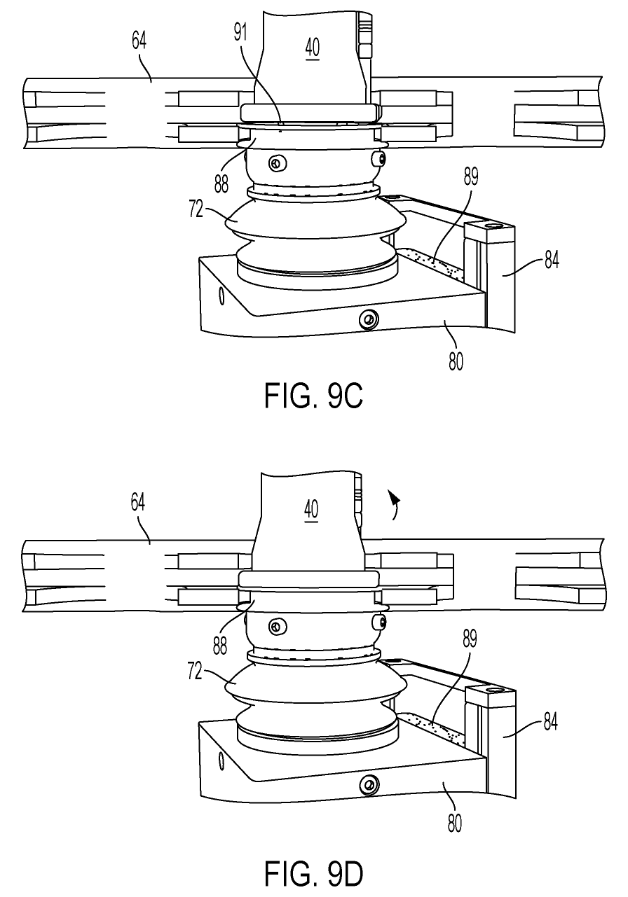

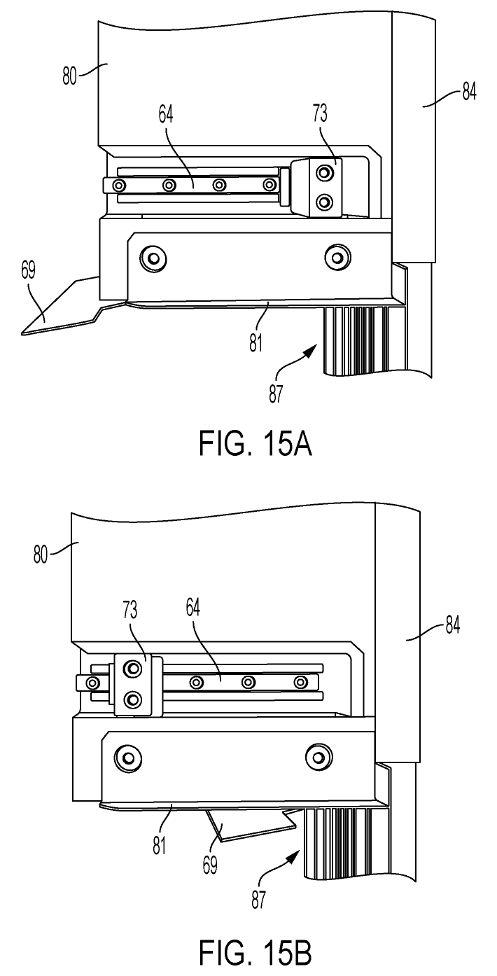

In accordance with certain aspects, the gripper may only have one adjustable suction surface, with one being set to a constant size. In accordance with further aspects, no adjustable surfaces may be provided, e.g., cases where the items it is grasping are the same or similar sizes. Additionally, instead of using mechanical actuation to adjust the vertical and horizontal sliders, grippers may use electromechanical actuation (e.g., motors or linear actuators inside the gripper), which would significantly decrease the time required to configure the gripper as discussed in more detail below. In some embodiments, both contact portions are fixed in position, and object engagement is achieved solely through modulation of vacuum exposure using flow control features. For example, the first contact portion 75 may remain stationary with its vacuum openings partially or fully closed via a flow control mechanism, such as in FIG. 15B, where the horizontal slider covers the openings. End-effectors in accordance with certain aspects of the invention may be used with a rack engagement system for automatically exchanging end-effectors. The system needs to know the yaw orientation of the end-effector on the attachment portion 40. FIGS. 9A - 9D for example, show an engagement system that includes a pin and a pin recess for alignment of the end-effector on the attachment portion. With reference to FIG. 9A, a spring-loaded pin 91 is provided on the attachment portion, and a pin recess 92 is provided on the annular mounting ring 88. During use in attaching the end-effector, the programmable motion device positions the attachment portion 40 above the end-effector on the rack, in which the pin 91 and the recess 92 are not yet aligned (FIG. 9B). The attachment portion is lowered further, and the pin contacts the annular mounting ring 88 (FIG. 9C). The end-effector attachment portion is then rotated until the pin 91 engages the pin recess 92 (FIG. 9D). The retracted position of the pin 91 (shown in FIG. 9C) is designed such that the magnetic fields of the magnets 94 are not yet so strong as to inhibit rotation of the attachment portion with respect to the end-effector. In accordance with further aspects, the magnets 94 may be provided as electromagnets that may be engaged only when the pin has been received within the pin recess (FIG. 9D). In this example, the attachment portion rotates until it is aligned with the end-effector on the rack. In some embodiments, the end-effector is modular, and may be exchanged using an automated rack system, such as those shown in FIGS. 9A–9D, 10A–10B, and 11A–11B. This enables dynamic selection and deployment of different end-effectors based on object type or task.

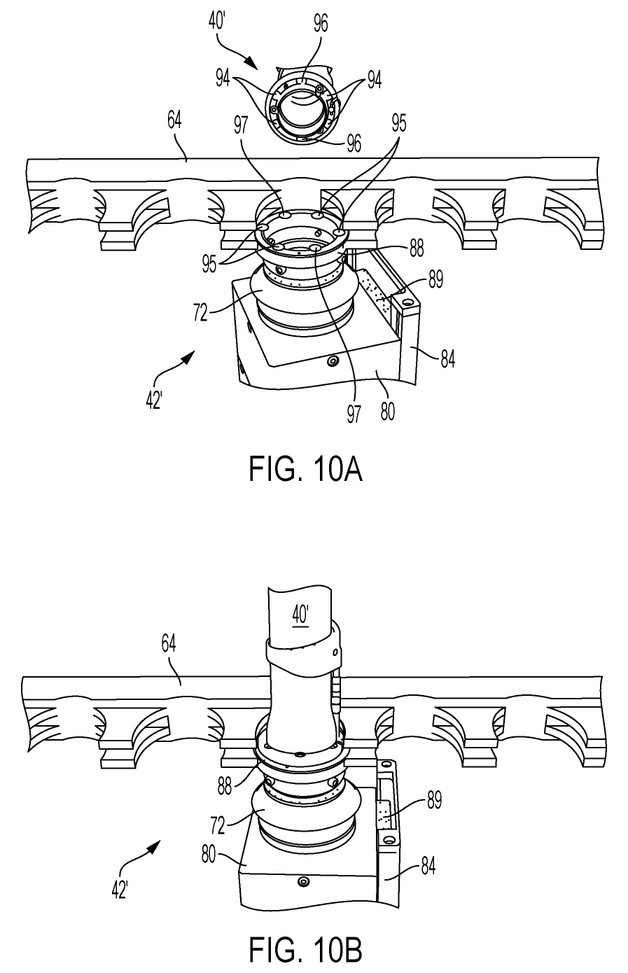

In accordance with further aspects, the magnets used for engaging the attachment portion to the annular attachment ring of the end-effector may themselves effect proper alignment of the end-effector with the attachment portion. FIGS. 10A and 10B, for example, show another attachment portion 40’ that includes s-magnets 94 and p-magnets 96, while the end-effector 42’ includes n-magnets 95 and s-magnets 97. FIG. 10A shows the magnets, and FIG. 10B shows the attachment portion 40’ coupled to the end-effector 42’, showing that the end-effector 42’ has been rotated under the polar forces of the magnets to both align with and engage the end-effector 42’ with the attachment portion 40’. The p-magnets align with the s-magnets, so irrespective of the original orientation of the end-effector with respect to the attachment portion, the parts will come together in one of two mutual orientations that are 180º apart; either orientation works because the end-effectors are symmetric. In accordance with further aspects, sets of magnets may be used that couple only in a single respective orientation of each end-effector and the attachment portion. In accordance with certain aspects, the attachment portion 40’ may also (or instead) be rotated to the alignment position. In each of the systems of FIGS. 9A - 10B, the control system may know or confirm the identity of each end-effector either by a scanner or camera system that detects a code on each end-effector or by providing low level magnets that detect low level distinct field patterns identifying each end-effector.

In accordance with further aspects, systems of invention may include locating features 112 that fit into grooves 110 as shown in FIGS. 11A and 11B. FIG. 11A shows an underside of the end-effector attachment portion 40 with the locating features 112 extending distally, and FIG. 11B shows the locating features 112 locked in the grooves 110 (only one is shown). These such locating features may provide additional torsional rigidity to the system.

The wedge-shaped distal portion of the vertical slider 84 (shown in FIG. 12B) may be moved between adjacent objects 29 in an input container such as input bin 28 (shown in FIG. 5) to create sufficient space for engagement with an individual object surface. The movement of the vertical slider 84 may be substantially downward or along another engagement direction to bring the contact surface into alignment with an object to be grasped. While in some embodiments this movement resembles a downward "plunge," in other embodiments the vertical slider may be moved through linear, rotational, or compliant motion to achieve the desired alignment. The high-flow vacuum is active during this engagement movement, and the vacuum force applied to the object increases as a greater portion of the vacuum openings (e.g., vertical open channels 87 in FIGS. 12B and 17A) come into proximity with the object surface. Through force feedback or motion-based inference—such as detecting resistance, actuator current, or position stall—the system may determine when sufficient engagement has been achieved and may cease further movement of the end-effector 42 (shown in FIG. 6). Once engaged, the object is lifted from the bin 56 and processed by being placed into an output container 26 or into the bagging station 16 (shown in FIG. 1). The horizontal sliding system may also be adjusted as appropriate to maintain sufficient contact with the selected object without engaging adjacent objects. For example, if the object presents a thin exposed face (e.g., books on end as shown in FIG. 22), the horizontal slider 75 may be adjusted to expose only a narrow vacuum surface. .FIG. 12A shows the vertical slider 84 in a retracted position and FIG. 12B shows the vertical slider 84 in an extended position. Again, the position of the vertical slider 84 with respect to the housing 80 may be achieved by pushing the vertical slider distally against a proximal end of the vertical slider, or by pushing the vertical slider proximally against a distal end of the vertical slider. For example, when moving toward an object such as a book on a conveyor or floor of a tote, the distal end of the vertical slider will move proximally against the conveyor or floor of the tote.

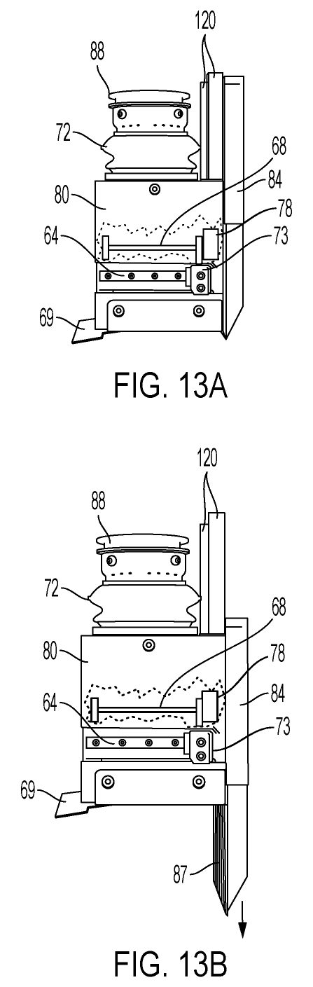

With reference to FIG. 13A, the position of the vertical slider may be controlled by one or more vertical position control systems 120 to either bias the position of the vertical slider downward (e.g., by a downward biased spring), or that actively drives the vertical slider downward and upward. FIG. 13A shows the vertical slider 84 in a retracted position and FIG. 13B shows the vertical slider 84 extended to an extended position along an engagement direction (downward as shown in FIG. 13B). FIGS. 13A and 13B also show that the movement of the actuator 76 discussed above may be powered, for example, by a motor 78 that drives a turn screw 68 within the housing 80. The slider tab 73 is attached to the driven turn screw 68 by a threaded mount, and when the screw 68 is rotated in one direction, the slider tab 73 moves in a forward direction, and the when reversed, the tab 73 moves in the rearward direction, adjusting the volume of vacuum flow at the planar horizontal surface provided by the open channels 67 (again, shown in FIG. 8B). In accordance with further aspects, the slider 73 may be moved by movement of the robot, and in particular, by bringing the end-effector adjacent a tab adjustment unit 134 with tab stops 130, 132 as shown in FIGS. 18A and 18B and discussed in more detail below. While electric motors may be used (e.g., motor 78 in FIG. 13B), actuation of the contact portions or sliders may also be achieved using pneumatic, hydraulic, magnetic, or electrostatic mechanisms. In some cases, actuation may occur by interaction with external features such as the tab stops 130, 132 shown in FIGS. 18A and 18B.

FIGS. 14A - 14C show the horizontal slider system that includes the horizontal slider 75 with the tab 73 attached thereto at one end, and the volume-blocking comb 77, sealing foam 79 and flexible flap 69 attached at the other more distal end. The flexible horizontal slider is directed by the inner curved surface 63 (shown in FIG. 7) as the tab is moved from an open position (FIG. 14A), to an intermediate position (FIG. 14B), to a closed position (FIG. 14C) in which the horizontal open channels (shown in FIG. 17A) are closed.

FIGS. 15A and 15B show enlarged views of the horizontal slider system within the housing. FIG. 15A shows the horizontal slider 75 (shown in FIGS. 14A - 14C) and tab 73 in a first position to fully open the planar contact surface provided by the horizontal open channels 67 (shown in FIGS. 8B and 17A), and FIG. 15B shows the horizontal slider 75 (again shown in FIGS. 14A - 14C) and tab 73 in a second position to fully close the horizontal open channels 67 (also shown in FIG. 17B).

With reference to FIG. 16A, the distal end of the elbow-shaped channel 61 in the housing 80 is positioned adjacent the cavity 85 in the vertical slider 84 as further shown in FIG. 16B. Again, vacuum is drawn through the vertical open channels 87 as well as any horizontal open channels 67 that are not blocked by the horizontal slider 75 and seal 69 (shown in FIG. 17A). Such vacuum from the open horizontal open channels 67 and the vertical open channels is drawn via the cavity 85 and channel 61 through the end-effector attachment assembly 66 to the vacuum source.

FIG. 17A shows the underside of the end-effector with the tab 73 moved to an open position to fully open the horizontal open channels 67, and FIG. 17B shows the tab 73 moved to a closed position to fully close the horizontal open channels with the slider 75 and sealing foam 79. The position of the tab 73 may be changed using a motorized system such as a linear actuator as discussed above, or the position of the tab 73 may be changed by motion of the end-effector itself. For example, FIG. 18A shows the end-effector 42 moving in a first direction such that the tab 73 contacts a first tab stop 130 on a tab adjustment unit 134, and FIG. 18B shows the end-effector 42 moving in a second opposite direction such that the tab 73 contacts a second tab stop 132 on the tab adjustment unit 134.

End-effector grippers in accordance with various aspects of the invention include an adjustable vertical slider that slides vertically within the main housing to adjust for the height of objects being grasped, includes a wedge-shaped tip to pry apart tightly packed items and pick individual objects. In accordance with certain aspects, such end-effectors include a friction-based internal seals to prevent air leaks while providing resistance for wedging actions, and vacuum pressure within the housing increases sliding resistance to aid in wedging operations. In accordance with further aspects, adjustment may be performed using a gripper adjustment plate or by leveraging known surfaces within the tote or work environment for faster realignment. Flexible flaps on the vertical slider may also improve sealing against uneven surfaces in accordance with certain aspects of the invention.

End-effectors in accordance with further aspects include an adjustable horizontal slider that is provided as a thin and flexible component, and housed in a track within the horizontal slider housing, allowing it to expand or contract the horizontal suction surface. In certain aspects, the horizontal slider wraps around a 180° track, enabling a compact design for effective operation in tight spaces, like cluttered warehouse totes. The slider may include features “teeth” on the underside to direct airflow while maintaining structural support under high vacuum pressure, and may include a flexible flap and rubber foam on the leading edge to improve sealing against uneven surfaces and prevent unintentional or multi-picks. In accordance with further aspects, flexible flaps on the sides of the horizontal slider housing may be used to fully seal the suction surface. The adjustable horizontal slider is mounted on a linear bearing and rail to protect the slider tab from external forces and torques in accordance with certain aspects of the invention.

Additionally, a compliant gripper of various aspects of the invention integrates a set of bellows to provide compliance, allowing the gripper to adapt to positional errors of the robotic arm. Such an end-effector may be equipped with grooves that lock into locating features mounted on a suction tube, which connects to a robotic arm. The robot may twist the suction tube to automatically lock the gripper in place, enabling quick swapping between gripper types. Such locating features may resist forces and torques, preventing the gripper from detaching under load.

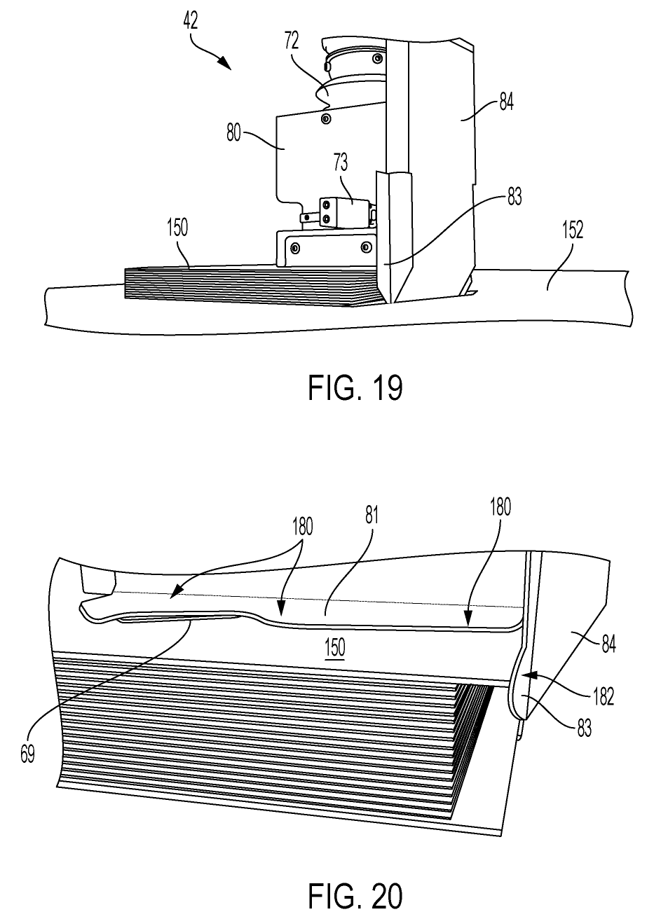

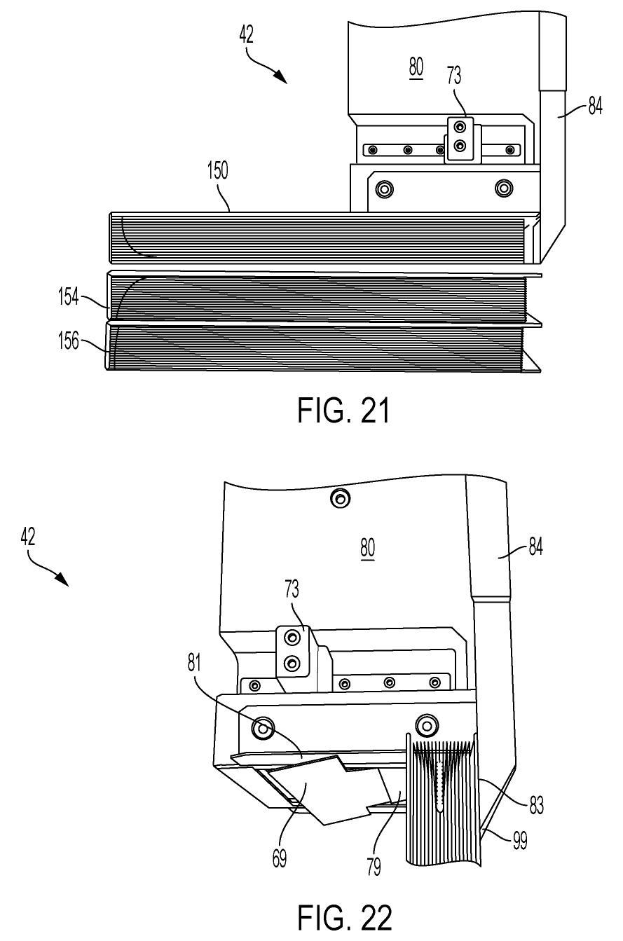

FIG. 19 shows the end-effector 42 grasping a book 150 on a flat surface 152. The horizontal slider tab 73 may be set to a position to provide the needed lift force on the facing surface of the book 150, and the vertical slider may be moved to contact the surface 152 to engage34 the end of the opposite cover of the book, thereby ensuring that the book 150 does not open when lifted. In particular, the vertical open channels 87 (shown in FIGS. 17A and 17B) served to keep the book from opening since vacuum is passing therethrough. FIG. 20 shows an enlarged view of the top surface of the cover of the book 150 being grasped by the flap 81 as it is drawn down onto the book’s cover over the flexible flap 69 (which compresses as shown at 180). The flap 83 is also drawn inward against the covers of the book 150 as shown at 182. Once the distance of travel of the vertical slider is known for the object 150, such an object 150 may then be picked from other objects 154, 156 as shown in FIG. 21 by knowing the thickness of the book and therefore knowing how far down the vertical slider should be positioned to grasp only the book 150.

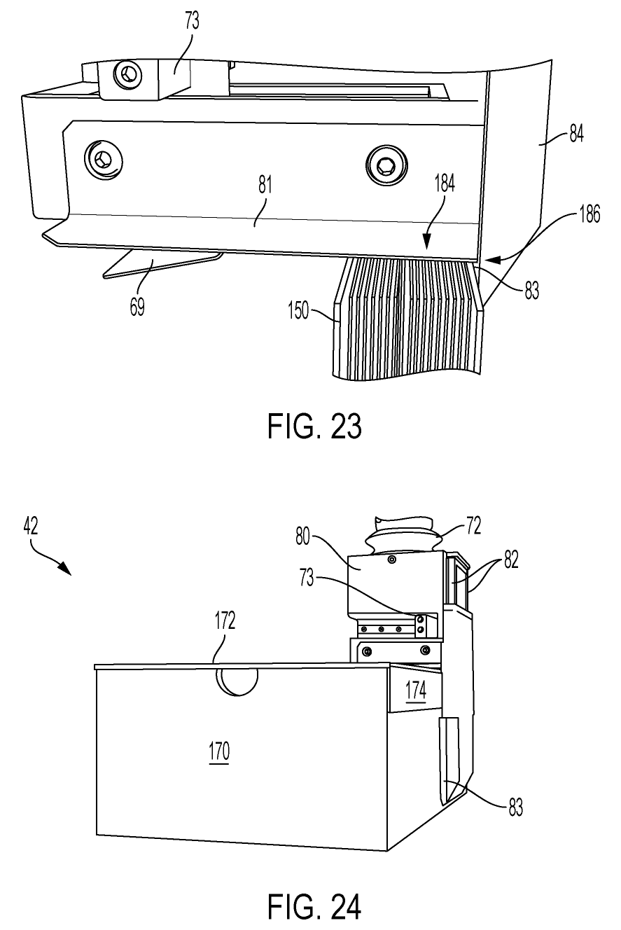

Books may also be grasped on end. FIG. 22 shows the end-effector 42 with the horizontal slider tab 73 positioned to limit the horizontal opening to the thickness of a book 160 (so as to avoid multi-picks), and the wedge-shaped tip 99 of the vertical slider 84 may be used to plunge between adjacent books. In this way, tightly-packed vertically-standing books may be processed from a tote. FIG. 23 shows an enlarged view of the top of the book 150 on end being grasped by the flap 81 as it is drawn down onto the book’s end as shown at 184, and the flap 83 is also drawn inward against the covers of the book 150 as shown at 186.

In accordance with specific aspects of certain end-effectors, the gripper’s horizontal and vertical sliders are motorized (and wirelessly controlled) and may be adjusted without mechanically moving them with methods such as the gripper adjustment tab stops. This may allow for faster adjustment between picks. In accordance with other specific aspects, the gripper may have no horizontal or vertical sliders but rather preset lengths that cannot be adjusted. This may be applicable, for example, for shoe boxes where having an exact length is not critical and since most shoe boxes have relatively similar dimensions.

FIG. 24, for example, shows the end-effector 42 with the horizontal slider tab 73 moved to increase the openness of the horizontal open channels, and the vertical slider is moved to a lower position of its vertical range. The end-effector 42 of FIG. 24 is thereby able to grasp together an openable top 172 and front flap 174 of a shoe box 170 such that the top 172 and front flap 174 do not open. Such a shoe box could also be grasped from either side or even from the back of the box since the top 172 will remain closed.

In addition to books and shoeboxes, the system may be used to handle a variety of objects, including soft goods, electronics, retail packaging, food items, and tools. It may be deployed in e-commerce fulfillment centers, industrial automation environments, logistics hubs, postal facilities, or retail backrooms, among other settings.

In accordance with various aspects, therefore, the invention provides an object processing system that includes an input area, a perception system, and an end-effector. Objects are presented to a programmable motion device at the input area. The perception system provides perception data regarding an object to be processed that is at the input area. The end-effector is coupled to the programmable motion device, and includes a first contact portion and a second contact portion. Each of the first and second contact portions is generally planar and each includes at least one opening through which vacuum may be provided. The second contact portion is generally non-parallel to the first contact portion, and the second contact portion is movable with respect to the first contact portion at least in an engagement direction such that more than one surface of the object may be grasped by the end-effector.

In accordance with further aspects, the second contact portion is generally mutually orthogonal to the first contact portion, and wherein the engagement direction is generally orthogonal to the first contact portion. In accordance with yet further aspects, the movement of the second contact portion with respect to the first contact portion is spring-biased, or the movement of the second contact portion with respect to the first contact portion is actively powered. In still further aspects, the first contact portion includes an actuator for adjusting a volume of vacuum flow at the first contact portion. and/or the second contact portion includes channels that provide vacuum flow to both the first contact portion and the second contact portion. Movement of the second contact portion relative the first contact portion also adjusts the amount of vacuum flow at the second contact portion. In still further aspects, the actuator moves a slider to cover or expose the at least one opening in the first contact portion, and/or the actuator is actively powered.

Those skilled in the art will appreciate that numerous modifications and variations may be made to the above disclosed embodiments without departing from the spirit and scope of the present invention.

What is claimed is:

1. An object processing system comprising:
an input area at which objects are presented to a programmable motion device;
a perception system for providing perception data regarding an object to be processed that is at the input area; and
an end-effector operatively coupled to the programmable motion device, the end-effector comprising a first contact portion and a second contact portion, each contact portion configured to engage an external surface of an object and each contact portion comprising at least one vacuum opening;
wherein the first and second contact portions are positioned non-parallel relative to one another to allow the end-effector to engage the object on separate surfaces, and
wherein the second contact portion provides a converging movement relative to the first contact surface, and said converging movement moves a converging slider relative to the second contact portion.

2. The object processing system of claim 1, wherein the converging movement is generally non-parallel to the first contact portion.

3. The object processing system of claim 1, wherein the first contact surface includes a plunging movement, said plunging movement is operable in an axial direction relative to the programmable motion device.

4. The object processing system of claim 1, wherein the plunging movement is controlled by an actuator.

5. The object processing system of claim 1, wherein a vacuum conduit is in communication with both contact surfaces.

6. The object processing system of claim 1, wherein a flow control mechanism is configured to vary the vacuum flow at the first contact surface.

7. The object processing system of claim 1, wherein movement of the converging slider increases or decreases a vacuum flow at the at least one opening in the second contact portion.

8. The object processing system of claim 1, wherein the actuator moves the slider toward the first contact portion and is configured to urge the object against the first contact portion.

9. An object processing system comprising:
an input area at which objects are presented to a programmable motion device;
a perception system for providing perception data regarding an object to be processed that is at the input area; and
an end-effector coupled to the programmable motion device, the end-effector including a first contact portion and a second contact portion, each of the first and second contact portions being generally planar and each including at least one opening through which vacuum may be provided, the second contact portion being generally non-parallel to the first contact portion, and the first contact portion including an actuator for adjusting a volume of vacuum flow at the first contact portion.

10. The object processing system of claim 9, wherein the second contact portion includes channels that provide vacuum flow to both the first contact portion and the second contact portion.

11. The object processing system of claim 9, wherein the first contact portion includes an actuator for adjusting a volume of vacuum flow at the first contact portion.

12. The object processing system of claim 11, wherein the actuator moves a slider to cover or expose the at least one opening in the first contact portion.

13. The object processing system of claim 11, wherein the actuator is actively powered.

14. The object processing system of claim 9, wherein the second contact portion is movable with respect to the first contact portion at least in an engagement direction such that more than one surface of the object may be grasped by the end-effector.

15. The object processing system of claim 14, wherein the second contact portion is generally mutually orthogonal to the first contact portion, and wherein the engagement direction is generally orthogonal to the first contact portion.

16. The object processing system of claim 15, wherein the movement of the second contact portion with respect to the first contact portion is spring-biased.

17. The object processing system of claim 15, wherein the movement of the second contact portion with respect to the first contact portion is actively powered.

18. A method of processing objects in an object processing system, the method comprising:
receiving an object at an input area proximate a programmable motion device;
providing an end-effector coupled to the programmable motion device, the end-effector including a first contact portion and a second contact portion, each of the first and second contact portions being generally planar and each including at least one opening through which vacuum may be provided, the second contact portion being generally orthogonal to the first contact portion;
moving the second contact portion with respect to the first contact portion at least in a direction that is generally non-parallel to the first contact portion; and
contacting more than one surface of the object to grasped by the end-effector.

19. The method of claim 18, wherein the method further includes adjusting a volume of vacuum flow at the first contact portion.

20. The method of claim 18, wherein the method further includes providing vacuum to the first contact portion and the second contact portion via a common passage.
